(19) United States
(12) Patent Application Publication
(10) Pub. No.: US 2017/0132174 A1
(43) Pub. Date: May 11, 2017

(54) NOVEL METHOD FOR THE FAST DERIVATION OF DELAUNAY TESSELATIONS

(71) Applicant: Jeffrey W. Holcomb, Irving, TX (US)

(72) Inventor: Jeffrey W. Holcomb, Irving, TX (US)

(21) Appl. No.: 14/934,160

(22) Filed: Nov. 6, 2015

(51) Int. Cl. G06F 17/11

(52) U.S. Cl. CPC G06F 17/11

(57) ABSTRACT

Three novel methods are provided which are valuable for the field of Delaunay tessellation derivation. The invention, implementable via various means such a digital processing system or an electronic circuit, has wide ranging applicability to numerous fields such as big data analysis, computer graphics and animation, mute planning, collision avoidance, computer vision, robotic vision, and etc. The first method of the invention details steps necessary to insert information into a data structuring in O(log n) while simultaneously retrieving sorted information relevant to the newly inserted information in O(1) time. The second method of the invention details and improvement to the Bowyer-Watson method that brings its runtime down to a tight O(n log n). The third method of the invention details steps necessary to compute the Delaunay tessellation of a set of line segment generators in [symbol] ^{k} in O(n log n) time.

### REFERENCES CITED

### U.S. Patent Documents

U.S. Pat. No. 7,679,615 B2 March 2020 Kim Et al.

U.S.20140300597 A1 April 2013 Holcomb

### OTHER PUBLICATIONS

A. Bowyer, “Computing Dirichlet tesselations”. The Computer Journal, pp. 162-166 1981.
D. Watson, “Computing the n-dimensional Delaunay tesselation with application to Voronoi polytopes”, The Computer Journal, pp. 167-172, 1981.
I. Boada, N. Coll, N. Madern, and J. A. Sellares, “Approximations of 2D and 3D generalized Voronoi diagrams,” International Journal of Computer Mathematics, vol. 85, pp. 1003-1022, July 2008.
M. Held, S. Huber, “Topoloty-oriented incremental computation of Voronoi diagrams of circular arcs and straight-line segments,” Computer-Aided Design, vol. 41, pp. 327-338, July 2009.
M. Held, “VRONI:An engineering approach to the reliable and efficient computation of Voronoi diagrams of points and line segments,” Computational Geometry, vol. 18, pp. 95-123, July 2001.
J. Holcomb and J. Cobb, “Voronoi Diagrams of Line Segments in 3D, with Application to Automatic Rigging,” ISVC, pp. 75-86, 2014.

### TECHNICAL FIELD

This invention relates to the automatic generation, derivation, and/or construction of Delaunay tessellations, and their dual Voronoi diagrams. In particular, this invention pertains to such Delaunay tessellations and Voronoi diagrams that are constructed from a set of line segment generators that exist in k-dimensional space. The constructed Delaunay tessellations are generally defined with respect to a graph such that each vertex in the graph represents a generator for the tessellation and each edge in the graph is interpreted as indicating two, mutual nearest-neighbor from the set of generators. The Voronoi diagram constructed from a Delaunay tessellation is understood to be constructed of cells that are polytopal (polygonal for two-dimensional space) regions of the data space. The data for said Voronoi diagrams can be any set of information, continuous or discrete. A component of this invention relates to the automatic rigging of 3D computer models, route planning, and molecular medicine.

### BACKGROUND OF THE INVENTION

Delaunay tessellations and Voronoi diagrams are a highly studied art due to their wide range of applicability to a diverse set of fields such as, but not limited to, molecular modeling, bio-informatics, robotic route planning, threat avoidance, and computer graphics. Delaunay tessellations and Voronoi diagrams being the dual of one another, it is widely known in the art that if one is able to construct a Delaunay tessellation for a set of generators then one is equally capable of constructing the Voronoi diagrams for the same set of generators. In fact, the first ever formal methods developed for Voronoi diagram construction, by Bowyer and Watson, begins with the construction of the Delaunay tessellation for the set of generators being used to construction the Voronoi diagram.

The traditional Voronoi diagram V is defined as the partitioning of a plane P containing n points, or generators g, into n distinct polygons such that each polygon contains only a single generator g and that every point p inside of a polygon POLY is closer to the generator g for POLY than the generator g′ for some other polygon POLY′. FIG. 1 shows a Voronoi diagram generated by a set of random points. In FIG. 1, 1 is a generator for the Voronoi cell 2. Given the definition of a Voronoi diagram, a Delaunay tessellation is then a nearest-neighbor mapping such that a pair p of generators <gᵢ, gⱼ> that share a common boundary are joined by an edge e(gᵢ, gⱼ) in the Delaunay tessellation for the set of generators. For two dimensional Voronoi diagrams, a common boundary would be an edge <vᵢ, vⱼ> connecting the Voronoi diagram vertices vᵢ, and vⱼ, In three dimensions this separator could be a face or curved surface. In FIG. 2 we present a Delaunay tessellation for a set of five line segment generators, 201, and a Delaunay tessellation for a set of fifty line segment generators, 202.

Despite the amount of research that has been performed in the art of Delaunay tessellation/Voronoi diagram construction, it is still difficult to automatically construct Voronoi diagrams for complex generators and higher dimensional spaces. Various groups have tried to automatically generate Voronoi diagrams for line segments, some even in 3D; however, a casual inspection of the treatment of the line segment endpoints in these diagrams usually invalidates the claim that said generated diagrams are Voronoi diagrams. Similarly, Boada and his group created a method that approximates a Voronoi diagram for a variety of shapes, including line segments; however, a close inspection of the cells computed by Boada et. al.'s method shows that the cells generated by said method in fact do not meet the requirement for a Voronoi cell.

The deficiency of the methods presented in prior work is largely due to the relaxed treatment that said groups give to the definition of a Voronoi diagram. To some degree this is necessary. For example, while Voronoi diagrams for point sets in high dimensional space can be generalized via the use of polytopes instead of polygons, more complicate generators, such as line segments, do require the use of curved faces. However, Boada et. al. and Held et. al. generalize the definition of a Voronoi diagram to the extent that they now allow generators to be associated with multiple Voronoi cells, Voronoi cells to be associated with multiple generators, and Voronoi cells that contain points that are closer to an alternative generator g′ than the primary generator g. Clearly, this violates both the definition and spirit of a Voronoi diagram. For the methods presented here, we define a Voronoi diagram V to be a partitioning of a space, or data set, into a set C of cells Cᵢ, called Voronoi cells, based upon a set G of generators; such that every point p∈Cᵢ, is closer to the generator i for Cᵢ, than any other generator j in G. In this definition, “closer” can be according to any distance measure. For example, but not limited to, one embodiment may use Euclidian distance to determine closeness; another embodiment might use the Manhattan distance; yet another method may use the Minkowski distance, and etc. Possibly the most significant fact about previous methods is the amount of work required to construct Voronoi diagrams. In the art of computer science the amount of work that must be performed by a method is described as the complexity of the method. The minimal amount of work that needs to be performed is designated by O-notation as O(ƒ(x); where ƒ(x) is a function of the size of the problem, or the amount of information, that is being supplied to the method to be worked upon by the method. Previous work has theorized that the minimal amount of work that is needed to construct a Delaunay tessellation for a set of line segments is O(n²). The method that we present here shows how to construct a Delaunay tessellation for a set of line segments in O(n log n); or a full order of magnitude of an improvement over the theoretical, but not yet achieved, best run time.

### SUMMARY OF INVENTION

This Summary is not intended to limit the scope of the claimed subject matter or identify key or essential features of the claimed subject matter. This Summary is only provides, in an abridged form, a selection of concepts that are further described in the Detailed Description.

With the previous paragraph in mind, this disclosure details a novel method for generating Delaunay tessellations from sets of line segment generators in O(n log n) time. Since the Delaunay tessellation of a set is the dual of the Voronoi diagram of the same set, this means that this disclosure also details how to construct Voronoi diagrams for sets of line segment generators in O(n log n). With the Delaunay tessellations and Voronoi diagrams constructed from the line segment generators, we can then use the resulting diagrams for the analysis of discrete data or infinite data spaces.

The construction of such Voronoi diagrams has a diverse set of applicable uses. Here, we will present one such use. Specifically, we will present the use of Voronoi diagram constructed via the first novel method for the purpose of automatically segmenting, rigging, and then subsequently animating an input model. The embodiment of the use case presented here is in no way mean to limit the potential use, or application, for Voronoi diagrams constructed using the following method. On the contrary, the vast number of uses is so numerous and diverse that it would be impractical to list all of such uses here. As such, the automatic rigging use case shown here is to be interpreted as a non-limiting, illustrative use case scenario.

The scope of this claim is not in any way intended to be limited according to the structure or format of the input data, or the medium for implementation of the methods presented here. The methods described here are typically, but not necessarily, implemented on a computational device of some manner that is capable of receiving, or loading, input data in such a manner as to enable the execution of the aforementioned methods.

### BRIEF DESCRIPTION OF THE DRAWINGS

Similarly numbered elements in the attached drawings correspond to one another.

FIG. 1 depicts an example Voronoi diagram for a set of input point generators.

FIG. 2 depicts two example Delaunay tessellations computed from two unique sets of line segment generators in [symbol] ³. The Delaunay tessellation in 201 was computed from a set of five line segment generators. The Delaunay tessellation in 202 was computed from a set of fifty line segment generators.

FIG. 3 depicts five scenarios for the possible interactions of line segment generators. 301 depicts two line segments 310 and 311 such that no point in 310 is closer to 311 than any other point in 310 and vice versa. 302 depicts the scenario where some point in 313 is closer to all points in 312 than all other points in 313. 303 depicts two line segments such that 314 has a point that is closer to all points in 315 and vice versa. 304 depicts two line segments that intersect at an endpoint. 305 and 306 depict line segments that overlap. 322 is the overlap for 305, and 323 is the overlap for 306.

FIG. 4 depicts some basic planes of separation between two line segment generators: one example plane of separation per use case in FIG. 3.

FIG. 5 depicts a Delaunay tessellation and Voronoi diagram for the vertices of a set of line segment generators.

FIG. 6 depicts just the Delaunay tessellation from FIG. 5. 601 is a line segment generator. 602 is an edge in the Delaunay tessellation.

FIG. 7 depicts a Voronoi diagram and the Delaunay tessellation for the set of line segment generators from FIG. 5 and FIG. 6.

FIG. 8 depicts the worst case scenario for the traditional Bowyer-Watson method. 801 is a Voronoi vertex v such that a multiplicity of generators (>k) fall on the circumcircle for v. 802 depicts the same scenario, but with the insertion of the reference radial 803.

FIG. 9 depicts a combined red-black tree/linked list data structure.

FIG. 10 presents the pseudo code for the improved Bowyer-Watson method.

FIG. 11 presents the pseudo code for the new red-black tree insert method.

FIG. 12 presents the pseudo code for the new, fast Delaunay tessellation of a set of line segment generators method.

FIG. 13 depicts the results from applying the new Delaunay tessellation method to the process of automatic segmentation and rigging of an input mesh. 1301 is an input mesh. 1302 is an input set of line segment generators. 1303 presents the mesh after being segmented by the results of the Delaunay tessellation. 1304 presents the results of using the results from 1303 to rig the input set of generators to the input mesh.

### DETAILED DESCRIPTION

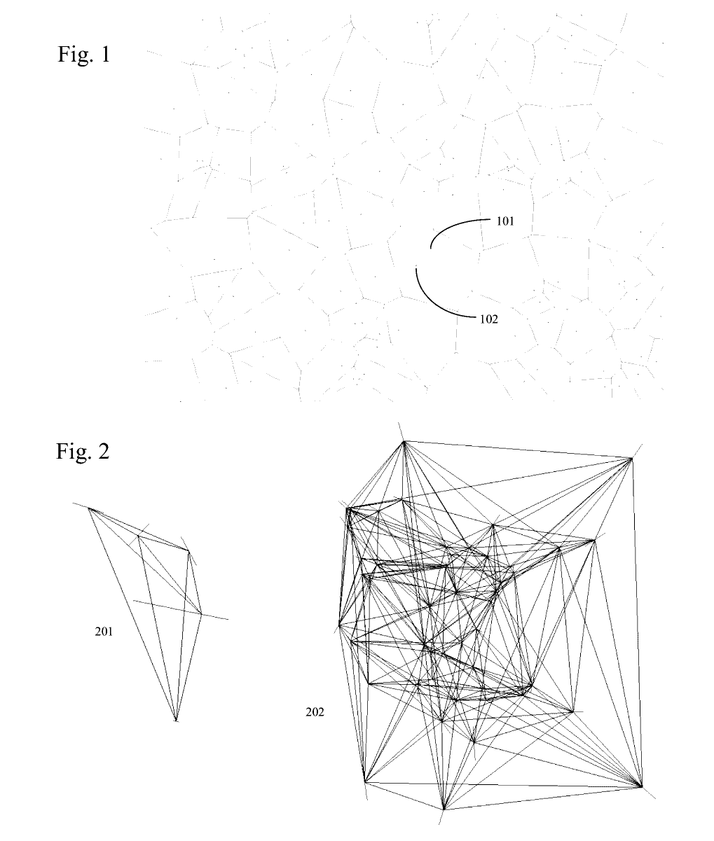

The presented disclosure is directed at the derivation of a Delaunay tessellation, Voronoi diagram, Voronoi-like diagram, Voronoi partitioning, and/or Voronoi-like partitioning of a mathematical space, or information, which we will from hence forth on refer to as data, for the purpose of analyzing data, or data space, so as to formulate conclusions, and/or predictions, with regards to the presented data, or data space. An example data space is the metric space in FIG. 1 over which the Voronoi diagram in FIG. 1 was computed. An example set of generators are the points 102 in FIG. 1. An example Voronoi cell is the cell 101 in FIG. 1.

FIG. 2 presents two Delaunay tessellations 201 and 202 computed from two separate and unique sets of line segment generators. 201 is computed using five line segment generators. 202 is computed using fifty line segment generators. To compute the Voronoi diagram from the Delaunay tessellations we need to use the equations solved by Holcomb for computing Voronoi diagrams of line segments. Holcomb presented four scenarios for line segment generator interactions.

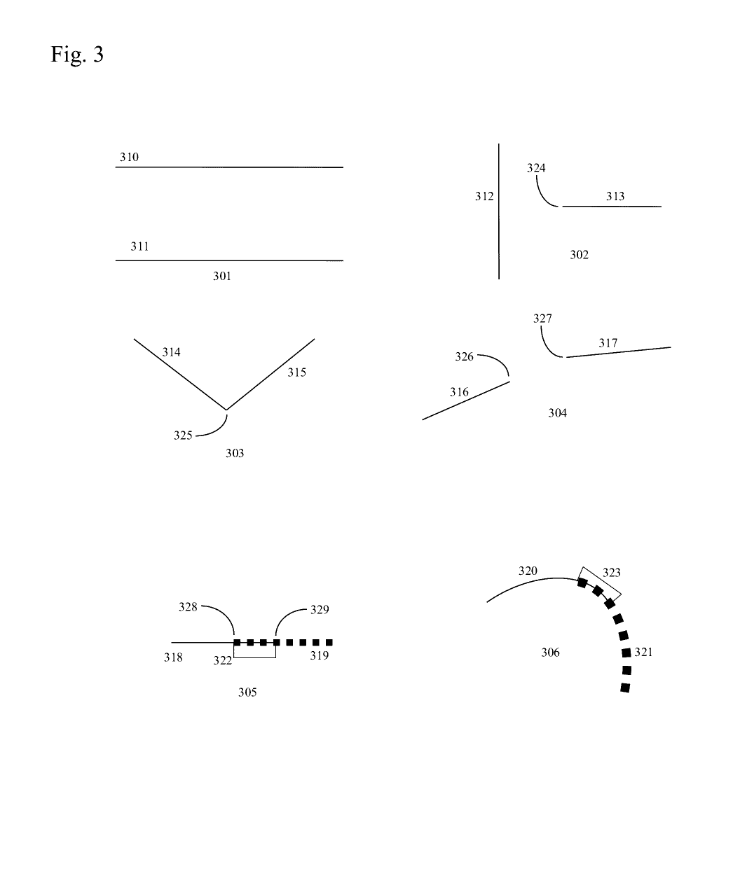

These four scenarios are presented in FIG. 3. The first scenario, 301, involves two line segments L₁ (310) and L₂ (311) such that no point p∈L₁ is closer to all points in L₂ than any other point p′∈L₁ [symbol] no point q∈L₂ is closer to all points in L₁ than some other point q′∈L₂. The second scenario, 302, involves two line segments L₁ (312) and L₂ (313) such that endpoint p₃ (324) for L₂ is closer to all points p∈L₁ than any other point p′∈L₂. The third scenario, 303, involves two line segments L₁ (314) and L₂ (315) that intersect at a common endpoint 325. The fourth, scenario, 304, involves two line segments L₁ (316) and L₂ (317) such that endpoint p₂∈L₁, where p₂ is 326, is closer to all of the points in L₂ than any other points p∈L₁ [symbol] endpoint p₃∈L₂, where p₃ is 327, than all points L₁ than any other point p″∈L₂.

We also present in FIG. 3 a fifth scenario, 305 and 306. This fifth scenario is when two line segments, or two splines in the case of 306, overlap for a region, 322 and 323 respectively.

The equation for the surface of separation between 310 and 311 can be defined as:

ƒ_{F}(s)=(s−proj_{L}_{₁}s)·(s−proj_{L}_{₁}s)−(s−proj_{L}_{₂}s)·(s−proj_{L}_{₂}s)=0.

The equation for the surface of separation between 312 and 313 can be defined as:

ƒ_{F}(s)=(s−proj_{L}_{₁}s)·(s−proj_{L}_{₁}s)−(s−p₂)·(s−p₂)=0.

The equation for the surface of separation between 314 and 315 can be defined as:

ƒ_{F}(s)=((\vec{L₂}×\vec{L₁})×(\vec{L₂}+\vec{L₁}))·(s−p₂)=0.

where \vec{Lₗ} is the direction of the line segment Lᵢ away from the point of intersection 325.

The equation for the surface of separation between 316 and 317 can be defined as:

ƒ_{F}(s)=(s−p₂)·(s−p₂)−(s−p₃)·(s−p₃)=0.

The equation for the surface of separation between 318 and 319 can be defined in the same manner as the equation for 304, but where the points p₂ and p₃ are the endpoints 328 and 329 of the overlapped region 322. The equation for the surface of separation between 220 and 321 can be defined in the same manner as the equation for 304, but where the endpoints are for the overlapped region 323.

Holcomb has previously described how such equations can be utilized to define a Voronoi cell.

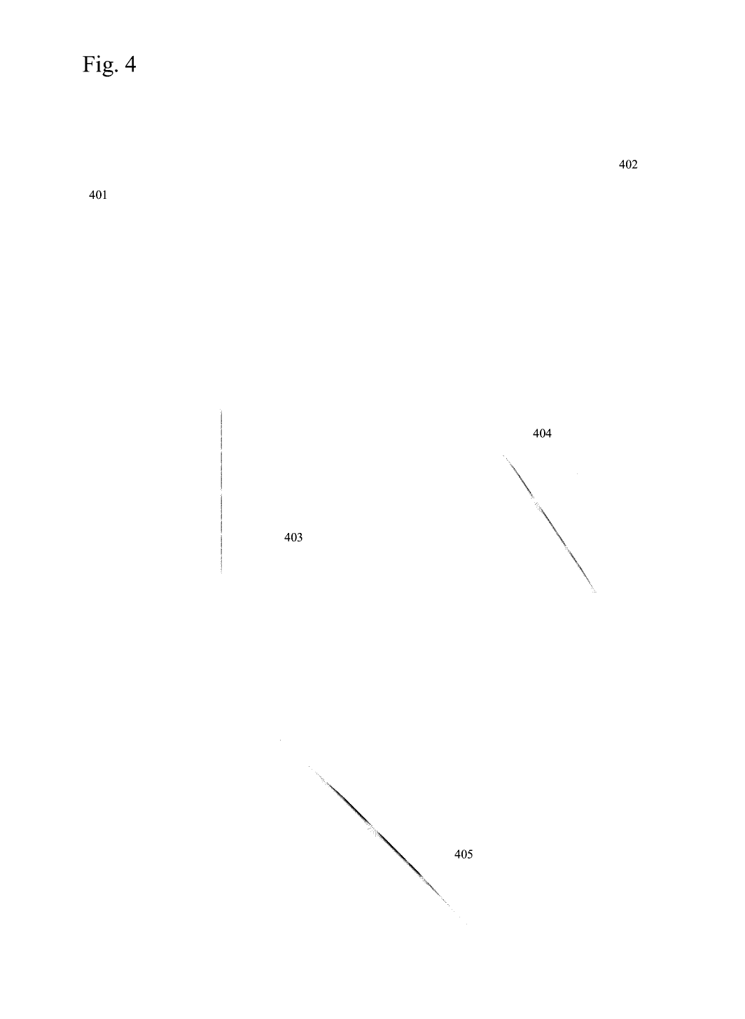

FIG. 4 presents examples of the planes of separation computable from the equations for the scenarios in FIG. 3. In FIG. 3, 401 shows the surface of separation for 301, 402 shows the surface of separation for 302, 403 shows the surface of separation for 303, 404 shows the surface of separation for 304, and 405 shows the surface of separation for 305.

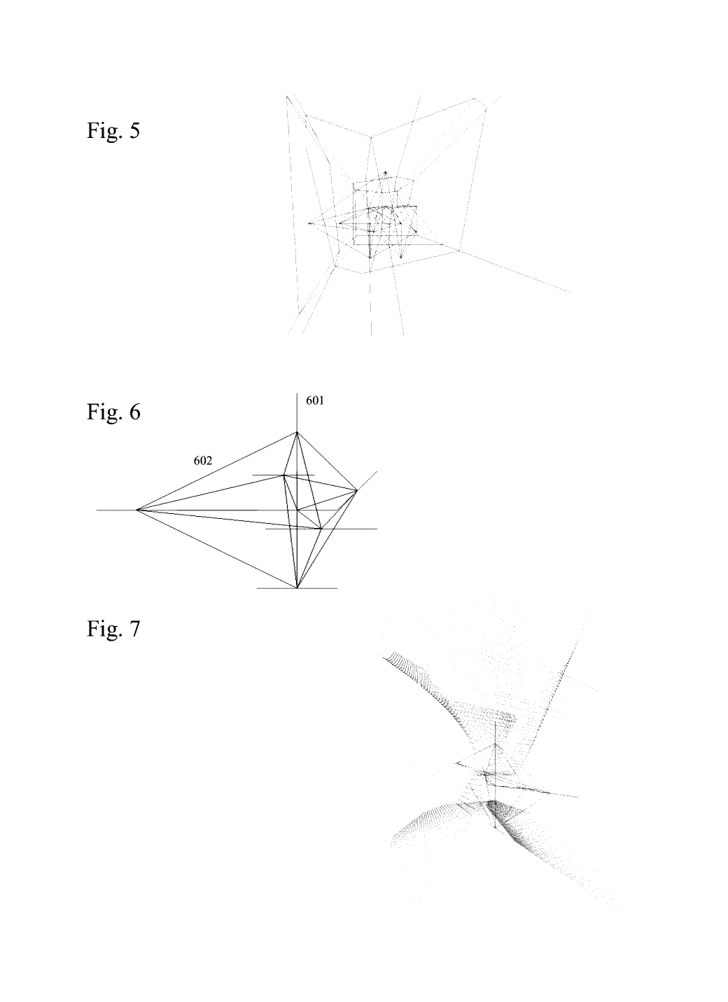

FIG. 5 presents an example Delaunay tessellation and Voronoi diagram for the endpoints for a set of line segment generators. FIG. 6 presents the Delaunay tessellation for the line segment generators presented in FIG. 5; where 601 is one such line segment generator and 602 is an example edge in the Delaunay tessellation for the line segment generators from FIG. 5 and FIG. 6. FIG. 7 presents the Voronoi diagram computed from the Delaunay tessellation in FIG. 6 using the equations for scenarios 301, 302, 303, 304, and 305/306.

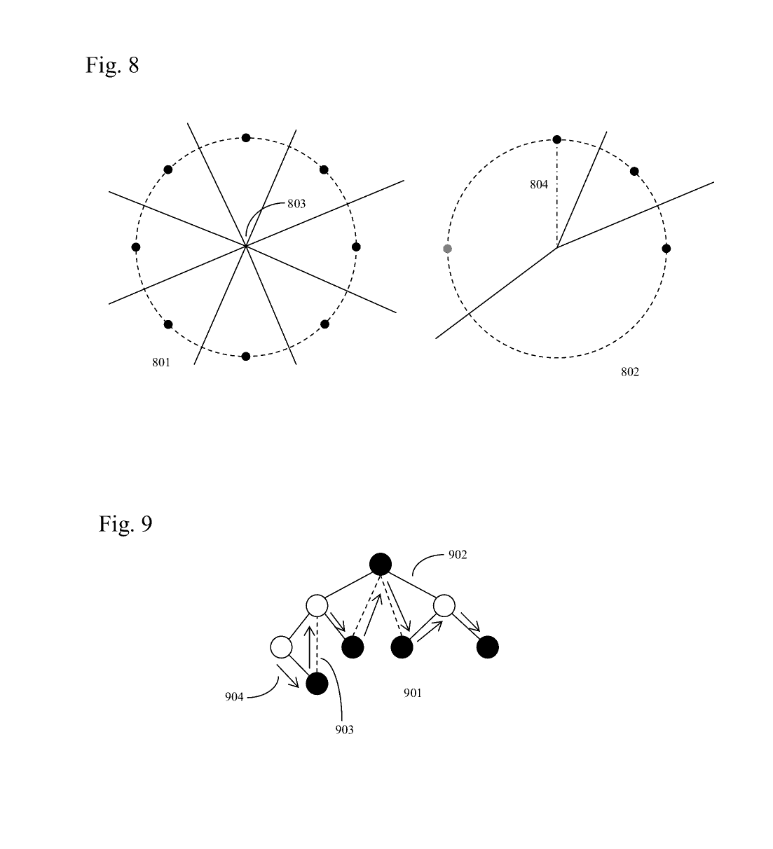

FIG. 8 presents the worst-case-scenario, 801 and 820, for the Bowyer-Watson method. This worst case scenario is the case when a multiplicity, or more than k+1 for k dimensional space, of generators are all equidistant from the same Voronoi vertex, 803. 802 presents the solution to such a worst-case-scenario: the addition of a reference radial position 804. By defining all generators that participate in the creation of 803 with respect to the position of the reference 804 we can guarantee a O(log n) insertion time for new generators: thereby enabling the tight O(n log n) runtime for the modified Bowyer-Watson method.

FIG. 9 presents a non-limiting representation for a combined red-black tree/sorted linked-list data structure, 901. 902 in FIG. 9 is an example edge belonging to the red-black tree portion of the combined red-black tree/sorted linked-list data structure. 903 in FIG. 9 is an example edge belonging to the sorted linked-list portion of the combined red-black tree/sorted linked-list data structure. The tree structure In FIG. 9 is provided by the red-black tree portion of the combined red-black tree/sorted linked-list data structure. The path, indicated by the arrows 904, that traverse the bottom of the tree are the portion of the graph that is provided by the sorted linked-list portion of the combined red-black tree/sorted linked-list data structure.

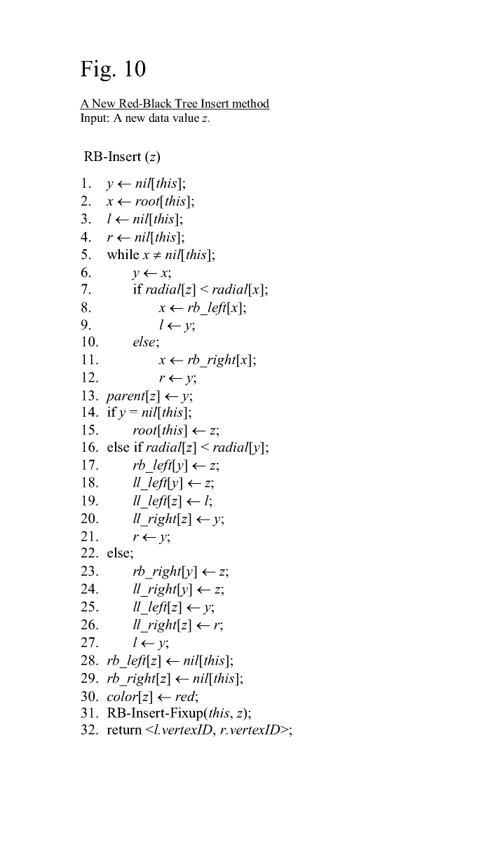

FIG. 10 is the pseudo code for the new insert method for the combined red-black tree/sorted linked-list data structure. There are three main differences between the new insert method and the old insert method. The first is that during tree navigation phase, lines 5 through 12, we keep track of the left and right indices for the sorted linked list. The second is that during the final insertion phase, lines 14 through 27, we add the sorted linked list left and right node information to the new node. This left and right node information can also be viewed as parent and child information for the sorted linked-list. The third, and final, change is that upon completion of the modified red-black tree insert method we return a pair containing the ID's of the node to the left and the node to the right of the current generator. For the improved Bowyer-Watson method, these left and right node ID's will point to the closest two generators to the new generator in the direction of the axis that the radial index represents.

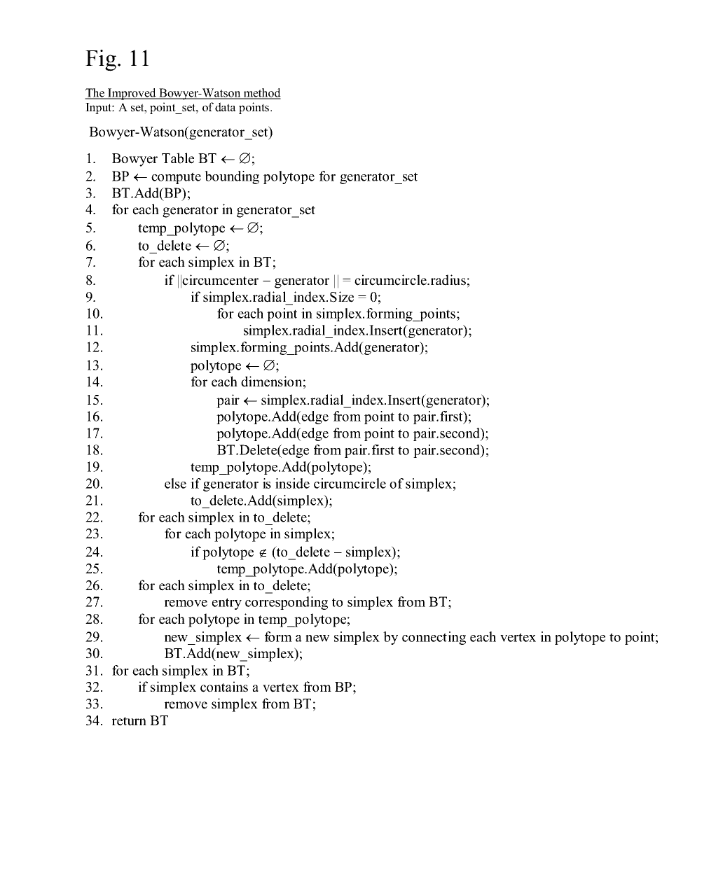

FIG. 11 presents the pseudo code for the new, improved Bowyer-Watson method. The new and improved Bowyer-Watson method is similar to the original methods with a few key exceptions. The first is that in line 8 where instead of checking to see if current generator is inside the circumcenter for the current simplex we start by checking to see of the current generator falls on the circumcenter for the current simplex. If it does, then we first check to see if the current simplex has a radial index defined for it; where said radial index is defined over a combined red-black tree/sorted linked list. If it does not, then we create one using the current forming points for the simplex. Then we add the new generator to the radial indices defined for each dimension over which our set of generators is defined. The pair of generators returned by the addition of the new generator to each index is then added to the forming points for the current polytope that is being constructed for the new Voronoi vertex. This addition of the combined red-black tree/linked list enables the quick O(log n) access time need to maintain a tight O(n log n) runtime for the Bowyer-Watson method for all scenarios. The remainder of the new, improved Bowyer-Watson method remains the same as before.

FIG. 12 presents the pseudo code for a new method for fast derivation of a Delaunay tessellation for a set of line segment generators. This new method starts by extracting and sorting the endpoints from the set of line segment generators. It then, in line 5, computes the Delaunay tessellation and Voronoi diagram for the set of endpoints for the set of line segment generators using the improved Bowyer-Watson method. Next, it constructs a line segment adjacency list using the information from the Delaunay tessellation computed in line 5. The compilation of this line segment adjacency list is the equivalent of the derivation of the Delaunay tessellation for the line segment generator set. With the Delaunay tessellation computed for the input set of line segment generators, the method, in lines 8 through 11, computes surface of separation for each line segment pair. Finally, in line 12, the new method returns the resulting Delaunay tessellation and Voronoi diagram for the input set of line segment generators.

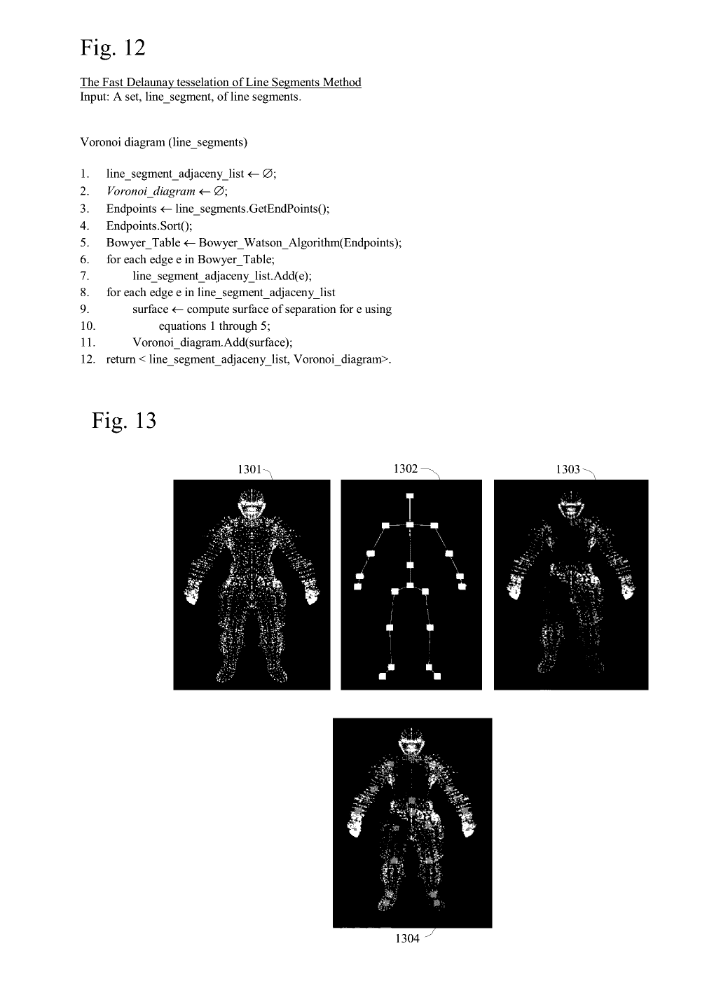

FIG. 13 presents the application of the technology presented in FIG. 12 for the automatic segmentation and subsequent rigging of an input animation skeleton to an input graphical model. 1301 represents the vertex information from a potential input model. 1302 represents a potential animation skeleton that is to be automatically rigged to 1301. 1303 presents an example segmentation of 1301 by 1302 via the method presented in FIG. 12 by defining 1302 as the set of line segment generators and using the resulting Delaunay tessellation/Voronoi diagram to induce a Voronoi partitioning of 1301. Finally, 1304 presents the embedded and rigged animation skeleton from 1302 such that each joint in 1302 is centered in the appropriate position in 1301 by centering it in the part of 1301 that lies on the surface of separation associated with each joint.

We Claim:

1. A novel method for storing information in O(n log n) time and retrieving said data in constant time using a combined red-black tree/sorted linked list data structure such that insertions into the red-black tree/sorted linked list structure require the normal O(log n) but that retrieval of information from the red-black tree/sorted linked list structure requires only O(1) time.

2. An improvement upon the Bowyer-Watson method for the derivation of Voronoi diagrams in R^{k}, where k≧2; whereby, a combined red-black tree/sorted linked list is utilized as a radial index such when a new generator is inserted into a subset S of generators participating in the worst-case scenario for the Bowyer-Watson method the insertion of the new generator into S still only requires O(log n) time: thereby enabling the modified Bowyer-Watson method to have a tight O(n log n) runtime instead of a worst-case runtime of O(n²).

3. The development of a novel, fast method for deriving Delaunay tessellations for sets containing line segments in, R^{k}, where k≧2, that can be described as follows:
first, the Delaunay tessellation, DT, is computed for the set of endpoints for the set of line segment generators in O(n log n) time; second, the Delaunay tessellation for the set of line segments generators is computed from DT in O(c12) time, where c is a factor proportional to the number of spheres with diameter equal to the length of the shortest line segment that can participate in the tightest packing of spheres around the longest line segment divided by 12, by scanning all edges in DT to see which line segments in DT share and edge;

[symbol]

4. The method of claim 3, the development of a novel, fast method for deriving Voronoi diagrams for sets containing line segments in R^{k}, where k≧2; whereby, the Voronoi diagrams, VD, are derived from the Delaunay tessellations DT described in claim 3 and then the surfaces that define the walls for VD are computed based on DT and the equations for the surfaces of separation between to line segments.
